(19) United States
(12) Patent Application Publication
(10) Pub. No.: US 2006/0164826 A1
(43) Pub. Date: Jul. 27, 2006

(54) Pocket lamp

(75) Inventors: Emil Ackermann, Wattwil (CH); Hans Hanseler, Ebmatingen (CH)

Correspondence Address: BROWDY AND NEIMARK, P.L.L.C.;624 NINTH STREET, NW, SUITE 300, WASHINGTON, DC, 20001-5303, US

(73) Assignee: Skylight AG, Wattwil (CH)

(21) Appl. No.: 10/521,172

(22) PCT Filed: Jul. 15, 2003
(86) PCT No.: PCT/CH03/00471

§ 371 Date: Jan. 14, 2005

(30) Foreign Application Priority Data
Jul. 19, 2002 (CH) 1277/02

(51) Int. Cl. F21L 4/00

(52) U.S. Cl. 362/157

(57) ABSTRACT

A pocket lamp (1) comprising a housing (10) which is penetrated by a luminous element (11) and in which a control electronics system and a rechargeable energy storage unit (71) are arranged. The housing (10) is also penetrated by a light collector (12) for supplying the energy storage unit (71) with energy and is embodied in a single cast piece in the form of a monoblock. The inventive pocket lamp is robust and rechargeable. It is suitable for use as a key ring.

### TECHNICAL FIELD

The invention relates to a pocket flashlight. It relates in particular to a simple pocket flashlight or to a multifunctional pocket flashlight.

### PRIOR ART

Small pocket flashlights are known from the prior art which can be attached to the bunch of keys or to the belt. They are either in the form of a disposable product and are discarded once their energy store has been discharged, or they have a replaceable battery.

WO 01/96781 thus discloses a small pocket flashlight which can be carried like a key holder. The pocket flashlight has a narrow, elongate housing in which a printed circuit board and a plate-shaped battery are arranged. The lighting element used is a light-emitting diode. A looped cord which is made of an elastic band and can be wound around a support element is fastened to the pocket flashlight. In order to secure the support element, the pocket flashlight has in its front region a groove into which the looped cord can be fitted.

Pocket flashlights are also known which have a rechargeable energy store. DE-A-199,17,108 thus discloses a pocket flashlight having a solar panel for charging the energy store. The lighting element used is a light-emitting diode. DE-A-201,03,295 describes a solar lamp having a solar panel and a light-emitting diode, all of the components being welded or adhesively bonded in a transparent film.

Furthermore, U.S. Pat. No. 339,230 discloses a model of a keyring pendant which has a display. This display is operated by means of sunlight.

WO 93/21503 discloses sunglasses having a solar panel and, integrated in the sunglasses, a UV sensor for measuring exposure to UV radiation.

### SUMMARY OF THE INVENTION

One object of the invention is to provide a pocket flashlight which has a rechargeable energy store and can be produced in a simple and cost-effective manner and is nevertheless of robust design.

This object is achieved by a pocket flashlight having the features of patent claim 1.

A further object of the invention is to provide a pocket flashlight which is designed as a keyring pendant for keys and can be produced in a simple manner.

This object is achieved by a pocket flashlight having the features of patent claim 7.

It is a further object of the invention to provide a pocket flashlight which requires as few electronic components as possible.

This object is achieved by a pocket flashlight having the features of patent claim 8.

The pocket flashlight according to the invention has a housing in which control electronics and an energy store, preferably a storage battery, are arranged. A lighting element, in particular a light-emitting diode, and a light collector are integrated in the housing. The housing is designed as a one-piece cast part in the form of a monoblock.

The energy store can be recharged by using a light collector, so that the pocket flashlight can be used over a relatively long time. Since the housing is designed as a cast part, it is very robust and cannot fall apart. In addition, the production costs are minimized.

The connection to a flexible strap having two loops means that keys can be fastened to the pocket flashlight without the use of a keyring. The keyring pendant can be produced in a simple and cost-effective manner, requires few parts, is easy to carry and additionally protects the pants pockets since there are no protruding, sharp edges or ends.

The control electronics according to the invention contain a microprocessor having an up and/or down converter which controls a coil which is connected in parallel with the light-emitting diode. As a result, the rectifier which is customarily used may be dispensed with. The printed circuit board can be relatively small and the production costs are minimized. This control system may also be used in pocket flashlights with conventional two-part housings.

The pocket flashlight may also be used as a multifunctional pocket flashlight, for example by being provided with a transmitter and/or with sensors for detecting environmental influences.

Further advantageous embodiments emerge from the dependent patent claims.

### BRIEF DESCRIPTION OF THE DRAWINGS

The subject matter of the invention is explained below with reference to preferred exemplary embodiments which are illustrated in the attached drawings, in which:

FIG. 1 shows a front view of a first embodiment of a pocket flashlight according to the invention with a looped cord attached;

FIG. 2 shows a side view of the pocket flashlight according to FIG. 1 with keys fastened thereto;

FIG. 3 shows a view of the pocket flashlight according to FIG. 1 from the rear;

FIG. 4 shows a view of a second embodiment of a pocket flashlight according to the invention;

FIG. 5 is a circuit diagram of the pocket flashlight according to the invention according to FIG. 1;

FIG. 6 shows a view of a third embodiment of the pocket flashlight according to the invention from the rear; and

FIG. 7 shows a view of a fourth embodiment of the pocket flashlight according to the invention from the rear.

### WAY OF IMPLEMENTING THE INVENTION

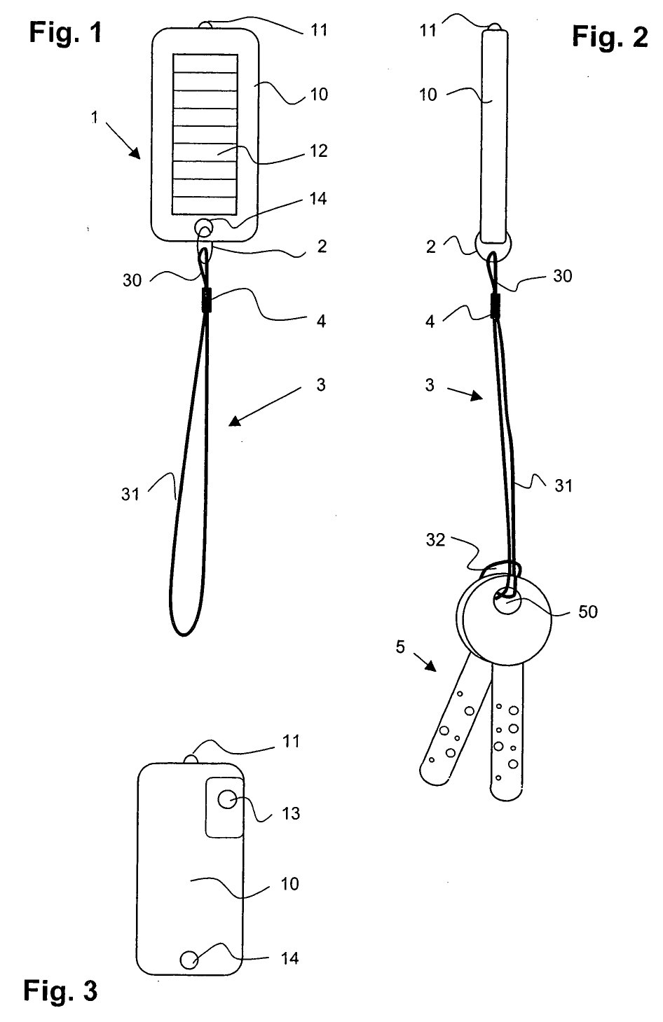

FIGS. 1 to 3 illustrate a pocket flashlight 1 according to the invention in the form of a keyring pendant which forms part of a key holder. The pocket flashlight 1 may however also be used in other areas. It may therefore, for example, be fastened directly to the waistband, to a pocket or to a backpack by means of a looped cord which is described further below.

The pocket flashlight 1 has a leadthrough opening 14 in the region of one of its shorter sides and a connecting ring 2 is attached to said region. A looped cord in the form of a strap 3 is fastened to this connecting ring 2. However, the strap 3 may also be arranged directly on the pocket flashlight 1.

The strap 3 is produced from a flexible, soft material, preferably a yarn composed of natural or synthetic fibers. The strap 3 may be woven or knitted. Shoelaces or similar straps are particularly suitable. The strap is preferably designed to be inelastic or only elastic to an insignificant extent.

The two ends of the strap 3 are joined together so that it is designed as an endless loop. Furthermore, the strap 3 is divided into a first and a second loop 30, 31. The two loops are formed by a fastening means 4 which firstly holds the two ends together and secondly connects these ends to a portion of the strap 3. The fastening means illustrated here is a clip 4. However, it is also possible to produce a connection by thermal stamping or to link the strap 3. It is also possible to make the first and second loops 30, 31 only at the ends of the strap 3 such that there is a single-strip connecting piece in the middle.

The first loop 30 is preferably much shorter than the second loop 31. In the example illustrated here, the first loop 30 is just long enough to allow free movement along the connecting ring 2. The length of the second loop 31 and the length of the entire looped cord are dimensioned such that the second loop 31 can be placed over the keyring pendant 1 and the first loop 30. These lengths are not usually too much greater than necessary. The second loop 31 is preferably typically 10% -20% longer than the rest of the key holder.

Furthermore, the strap 3 has a material thickness which is doubled and at least in the region of the second loop 31 is thin enough for the second loop 31 to be led through fastening holes 50 in keys 5.

In order to fasten a key 5, the second loop 31 is pulled through a fastening hole 50 in the key 5. This is repeated as many times as there are keys 5 to be fastened. When all of the keys 5 are lined up, the loop 31 is then placed over the keyring pendant and the first loop 30. By pulling the keyring pendant 1 and the keys 5 in opposite directions, the second loop 31 forms a third loop 32 around the keys 5 such that the latter are securely held. Since the second loop 31 is designed to be short enough, it will not slide back over the keyring pendant 1 of its own accord. In order to remove the keys 5, it is simply a matter of performing the sequence in reverse.

The pocket flashlight 1 may be of any shape. However, it is preferably of square design. In addition, the pocket flashlight 1 preferably has a thickness which is much smaller than its length and its width. Typical dimensions are a length of at most 6 cm, a width of at most 3 cm and a thickness of typically 1 cm.

The pocket flashlight 1 has a housing 10 in which a small printed circuit board having control electronics and a rechargeable energy store 71, in particular a storage battery, are arranged. A light collector 12, in particular a solar panel, is integrated in a side face of the housing 10. Other types of light collector may be used, for example an array of photodiodes. The light collector 12 is preferably located in a broad, long side face of the housing 10. The light collector is active in the visible region of the solar spectrum in particular. It is preferably also highly efficient in artificial light. The light collector 12 is used to charge the energy store 71. In order that the latter is charged quickly enough, the light collector 12 extends over a substantial portion of the side face of the housing 10. The light collector 12 preferably has a surface area of at least 3 cm by 1.5 cm, that is to say it extends over 50% or more of the area of the housing 10.

A lighting element, preferably a white light-emitting diode 11, is electrically connected to the printed circuit board. This light-emitting diode 11 is integrated in the housing 10. It usually protrudes out of the housing 10. It is arranged on a narrow, short side face of the housing 10. This is preferably that side face which is opposite the fastening location of the housing 10 on the strap 3.

Furthermore, an on button 13 is arranged on the rear side of the housing 10 and the lamp 11 can be switched on by means of this on button. Either the button 13 has to be kept pressed in order to light the lamp, or there may be an off button. The off button may be a different or the same button as the on button 13. Furthermore, it is possible to provide in the electronic circuit a time switch which switches off the lamp after a predetermined period of time. Flashing effects are also possible.

The housing 10 according to the invention is designed as a one-piece cast part in the form of a monoblock. It is preferably produced from resin or a suitable plastic. In this case, the abovementioned electrical components of the pocket flashlight are cast in the monoblock. In the exemplary embodiment illustrated in FIGS. 1 to 3, the cast part forms the outer housing of the pocket flashlight.

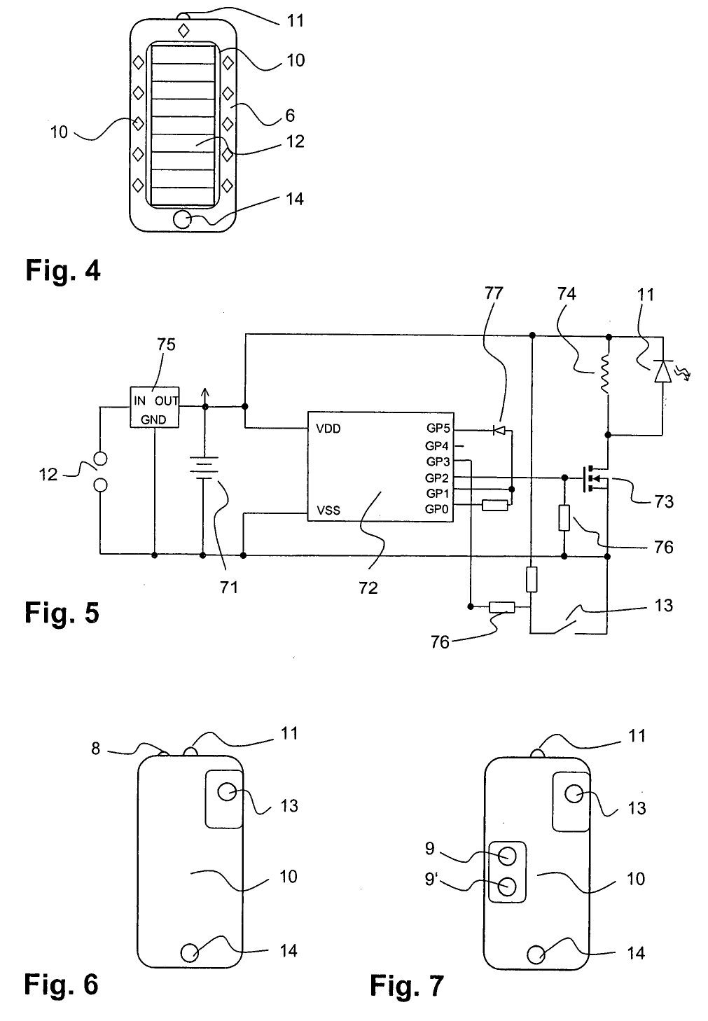

In the exemplary embodiment according to FIG. 4, the housing 10 is at least partially surrounded by a hollow shell 6. This hollow shell 6 is preferably produced from metal. In this case, during production of the pocket flashlight the individual electrical components are placed into the hollow shell 6 and the latter is filled. This gives the pocket flashlight an elegant appearance. In a preferred embodiment, the hollow shell 6 does not surround the housing 10 completely, such that the pocket flashlight has an external appearance which is marked by the alternating pattern of the material and the color of the hollow shell 6 and of the housing 10.

FIG. 5 is a circuit diagram of the pocket flashlight 1 according to the invention. As can be seen, this circuit does not require a rectifier. The light collector 12 charges the energy store 71 by means of a voltage regulator 75. Said energy store operates the microprocessor 72 which comprises an up and/or down converter. The microprocessor 72 controls the coil 74 by means of a transistor 73, in particular a MOSFET. The light-emitting diode 11 is connected in parallel with the coil 74. Various resistors 76 and a diode 77 are used to connect up the microprocessor correctly. The on button 13 may be used to switch on the control electronics, select further functions and/or switch off the control electronics.

FIG. 6 illustrates a third embodiment of the pocket flashlight 1 according to the invention. In this exemplary embodiment, in addition to the light-emitting diode 11, a transmitter 8 is present at a suitable location. It may also be used in place of the light-emitting diode 11, with the housing 10, the light collector 12 and the energy store 71 being designed in a manner identical to that described above. However, the housing 10 used may also be a conventional two-part housing. The transmitter 8 is connected to the microprocessor 72 and is used to transmit a code to an external appliance or an external system, for example an automatic garage-door opener or an alarm system. The code is transmitted by means of an infrared signal or by radio.

FIG. 7 illustrates a fourth embodiment. In this case, at least one sensor for detecting environmental influences is present in addition to or in place of the light-emitting diode 11, this sensor also being operated by means of the energy store 71 which can be charged via the light collector 12. Said sensor is also arranged at a suitable location. In the example illustrated here, said sensor is an infrared sensor 9 and/or a UV sensor 9′. In addition, an acoustic or optical signaling element is arranged in the housing, said element being coupled to the sensor and signaling possible overexposure to the radiation in question.

The pocket flashlight according to the invention is of robust design and is rechargeable. In addition, it is suitable for use as a keyring pendant.

### LIST OF REFERENCE SYMBOLS

1 Pocket flashlight
10 Housing
11 Light-emitting diode
12 Light collector
13 On button
14 Leadthrough opening
2 Connecting ring
3 Strap
30 First loop
31 Second loop
32 Third loop
4 Fastening means
5 Keys
50 Fastening hole
6 Hollow shell
71 Energy store
72 Microprocessor
73 Transistor
74 Coil
75 Voltage regulator
76 Resistor
77 Diode
8 Transmitter
9 Infrared sensor
9′ UV sensor

1. A pocket flashlight having a housing in which a lighting element is integrated and in which control electronics and an energy store are arranged, wherein a light collector for supplying energy to the energy store is integrated in the housing, and in that the housing is a one-piece cast part in the form of a monoblock.

2. The pocket flashlight as claimed in claim 1, wherein the housing is composed of plastic or resin.

3. The pocket flashlight as claimed in claim 1, wherein the housing is at least partially surrounded by a hollow-shell, in particular made of metal.

4. The pocket flashlight as claimed in claim 1, wherein the housing is of square design, in that the lighting element is integrated in a narrow, short end face of the housing and in that the light collector is arranged in a broad, long side face of the housing (10).

5. The pocket flashlight as claimed in claim 4, wherein the light collector extends over a substantial portion of the side face of the housing.

6. The pocket flashlight as claimed in claim 1, wherein the pocket flashlight is a keyring pendant.

7. The pocket flashlight as claimed in claim 6, wherein a looped cord in the form of a flexible strap is attached to the pocket flashlight, the looped cord having at a first end a first loop for fastening to the pocket flashlight, and having at a second end a second loop for leading said strap through a fastening hole in a key, and in that the length of the second loop and the length of the looped cord are dimensional such that the second loop can be placed over the pocket flashlight and the first loop (30) in order to hole or remove the key.

8. The pocket flashlight as claimed in claim 1, wherein the lighting element is a white light-emitting diode, wherein the energy store operates a microprocessor which controls a coil, and wherein the light-emitting diode is connected in parallel with the coil.

9. The pocket flashlight as claimed in claim 1, wherein a transmitter for controlling an external appliance or an external system is arranged in the housing.

10. The pocket flashlight as claimed in claim 1, wherein at least one sensor for detecting environmental influences, in particular an infrared sensor and/or a UV sensor, is arranged in the housing.
